(19) United States
(12) Patent Application Publication
(10) Pub. No.: US 2007/0060430 A1
(43) Pub. Date: Mar. 15, 2007

(54) Multiple ribbed pulley and system

(76) Inventors: John Alden, Rochester Hills, MI (US); Mitchell Reedy, Springdale, AR (US)

Correspondence Address: Jeffrey Thurnau;The Gates Corporation, MS:, IP Law Dept. 10-A3, 1551 Wewatta Street, Denver, CO, 80202, US

(21) Appl. No.: 11/223,615

(22) Filed: Sep. 9, 2005

(51) Int. Cl. F16G 1/00; F16G 9/00

(52) U.S. Cl. 474/237

(57) ABSTRACT

A multiple ribbed pulley and a pulley and belt system having a pulley rib and groove profile configuration that cooperates with a belt shape when the belt is under a tensile load.

### FIELD OF THE INVENTION

The invention relates to a multiple ribbed pulley and a pulley and belt system, and more particularly, to a pulley and a pulley and belt system having a pulley rib and groove profile configuration that cooperates with a belt shape when the belt is under a tensile load.

### BACKGROUND OF THE INVENTION

Proper operation of a V-belt drive involves placing a belt into the grooves of mating pulleys and applying tension to the belt.

Most V-belt drives operate with a relatively small amount of belt elongation. However, when tension is added to the system the belt will elongate longitudinally. As V-belt elongation increases, belt width and thickness decreases. The outer edges of the belt experience more of a change in width than the center section of the belt. In the case of a multi-strand belt, the outer strands will have different cross sectional dimensions than the center strands. Because all the pulley grooves are the same dimension and at a consistent spacing, they will not match the shape and spacing of a belt under tension.

This mismatch in profile between the pulley and belt will cause noise, accelerated belt wear and reduced belt durability.

Representative of the art is U.S. Pat. No. 4,981,462 to White (1991) which discloses an endless power transmission belt construction, a rotatable pulley therefore, a combination of the belt construction and pulley and methods of making the same are provided, the belt construction having opposed side edges and having an inner surface defining a plurality of longitudinally disposed and alternately spaced apart like projections and grooves for meshing with an outer peripheral ribbed surface of a rotatable pulley, each projection of the belt construction having a generally V-shaped transverse cross-sectional configuration defined by two substantially straight side edges that converge from the respective apexes of the grooves of the belt construction that are on opposite sides of that projection to an apex of that projection, the side edges of each projection of the belt construction defining an angle of approximately 60° therebetween with the thickness of the belt construction being substantially the same as the thickness of a similar belt construction wherein the angle is approximately 40° and with the distance between the center lines of the grooves of the belt construction that are on opposite sides of that projection being larger than such distance of the similar belt construction.

What is needed is a multiple ribbed pulley and a pulley/belt system having a pulley rib and groove profile configuration that cooperates with a belt shape when the belt is under a tensile load. The present invention meets this need.

### SUMMARY OF THE INVENTION

The primary aspect of the invention is to provide a multiple ribbed pulley and a pulley and belt system having a pulley rib and groove profile configuration that cooperates with a belt shape when the belt is under a tensile load.

Other aspects of the invention will be pointed out or made obvious by the following description of the invention and the accompanying drawings.

The invention comprises a multiple ribbed pulley and a pulley and belt system having a pulley rib and groove profile configuration that cooperates with a belt shape when the belt is under a tensile load.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross section of a belt and pulley.

FIG. 2 is a cross section of a belt under a tensile load engaged with a pulley.

FIG. 3 is a cross-sectional schematic of the pulley grooves.

FIG. 4 is a cross-sectional view of a tensile loaded belt engaged with an inventive pulley.

FIG. 5 is a cross-sectional schematic of the pulley grooves.

FIG. 6 is a cross-sectional view of a tensile loaded belt engaged with an inventive pulley.

FIG. 7 is a schematic cross-sectional view of the inventive pulley rib configuration.

FIG. 8 is a cross-sectional view of a tensile loaded belt engaged with an inventive pulley.

FIG. 9 is a cross-sectional view of a comparison of the profile of a prior art pulley and the profile of an inventive pulley.

### DETAILED DESCRIPTION OF THE PREFERRED EMBODIMENT

The invention comprises a multiple ribbed pulley having a rib and groove arrangement that is configured to complement a belt shape when the belt is subjected to operating tension (tensile load), and a system comprising a pulley and belt combination.

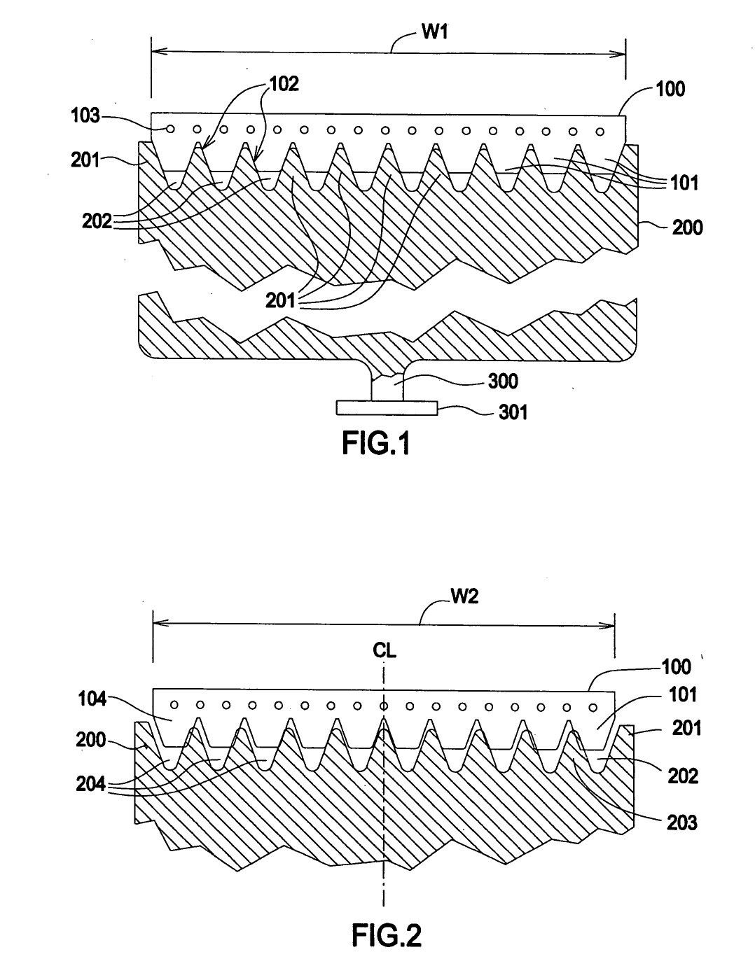

FIG. 1 is a cross section of a belt and pulley. Belt 100 comprises ribs 101 and grooves 102. Ribs 101 run in a longitudinal direction on the belt 100. Tensile cords 103 also run in a longitudinal direction in the belt. Belt 100 is also referred to as a V-ribbed, multi-ribbed or multiple ribbed belt.

Pulley 200 comprises a belt bearing surface having ribs 201 and grooves 204. Ribs 101 in belt 100 engage grooves 202 in pulley 200. Ribs 201 in pulley 200 engage grooves 102 in belt 100. A web 300 connects the belt bearing surface to a hub 301. Hub 301 is used to connect the pulley to a shaft (not shown).

The belt is constructed using material and methods known in the art. The belt may comprise polymeric materials including polybutadiene, EPDM, HNBR, SBR, polychloroprene, natural rubber and isobutene isoprene rubbers, or a combination of two or more of the foregoing. The tensile cords may comprise aramid, polyester, fiberglass, nylon, polyolefin, PBO, PEN, carbon, metal wire/cable, cotton and rayon, or a combination of two or more of the foregoing.

Such belts are typically used on accessory belt drive systems on automotive engines, although they may also be used on various industrial applications including transmitting power for driving pumps, compressors and engines, namely, any installation where power transmission by belt is desired. The belt shown in FIG. 1 is under minimal or no tensile load and has a width W1.

FIG. 2 is a cross section of a belt under a tensile load engaged with a pulley. In this FIG. 2 belt 100 is under a tensile load as would be normally experienced in an operation condition. Due to the tensile load the outermost ribs 101, 104 are drawn slightly toward the centerline CL of the belt 100, namely, the belt is slightly stretched and therefore somewhat narrower by virtue of the tensile load. The belt has an operating width W2 which is less than width W1. The shape of the narrowed belt is shown superimposed on the pulley profile.

The optimum fit of the belt in the pulley is adversely affected by the narrowing of the belt under load, particularly with respect to the relationship of the outer ribs 101 and 104 with grooves 202, 204 where the effect is most pronounced.

The instant invention configures the pulley dimensionally to allow for the narrowing of the belt so that the belt achieves a proper fit with all pulley grooves when in operation and under load. Improved fit increases the useful life of the belt while decreasing the tendency to make noise caused by the improper engagement of the belt ribs with the pulley grooves. The inventive pulley comprises grooves having a spacing between adjacent grooves that decreases as a function of the distance of the grooves from the pulley centerline CL.

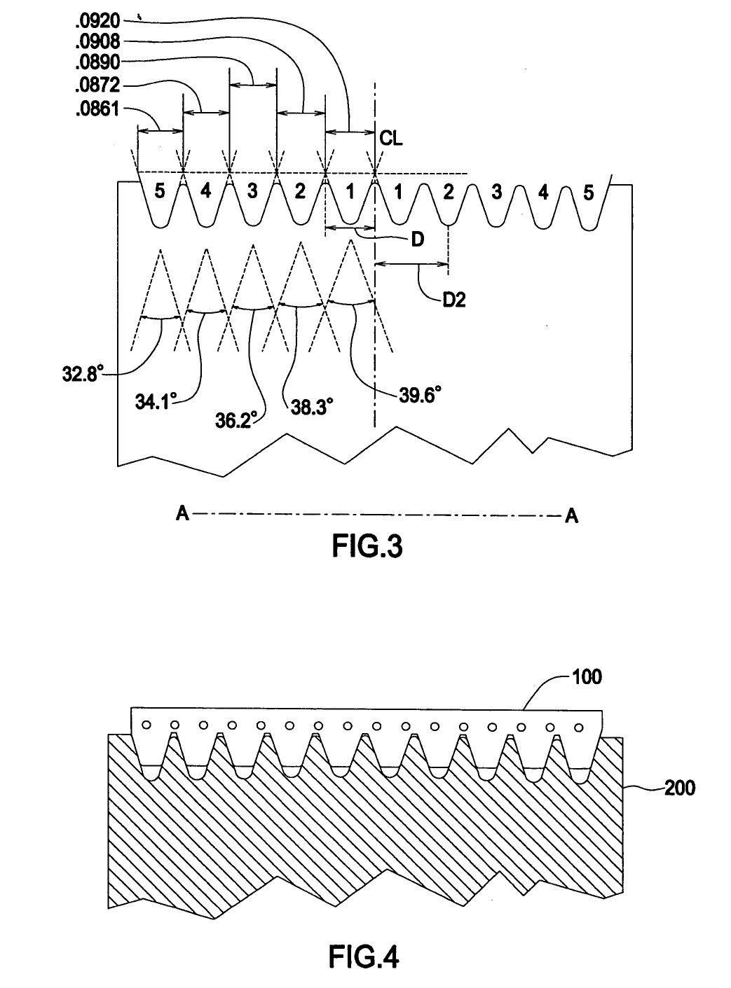

Referring to FIG. 3, which is a cross-sectional schematic of the inventive pulley, the spacing of the ribs for the inventive pulley in a direction outward from the pulley centerline CL, (i.e. parallel to an axis of rotation A-A), is calculated using Equation 1.

In the inventive pulley, the belt bearing surface has a plurality of pulley ribs and pulley grooves. The pulley rib spacing between adjacent pulley ribs decreases as the distance (D) of each pulley rib increases from a pulley centerline (CL). Further, the pulley groove angle decreases as the distance (D2) of each pulley groove increases from a pulley centerline (CL).

$$\begin{matrix}Equation 1 \text{-} Pulley Rib Spacing & \\ {S}_{gn} = tan ( \frac{{θ}_{n}}{2} ) \times [ {d}_{B} \times ( \frac{1}{sin ( {θ}_{n} / 2 )} - \frac{1}{sin ( {θ}_{1} / 2 )} ) + \frac{{S}_{g}}{tan ( {θ}_{1} / 2 )} ] & \end{matrix}$$

Where:
S_{gn}=rib spacing for n^{th} rib
S_{g}=nominal rib spacing
d_{B}=ball diameter
θₙ=pulley groove angle, in degrees, for the n^{th} pulley groove
θ=nominal pulley groove angle in degrees

Note: For these equations, ribs are numbered starting from the centerline of the pulley moving towards the outer edge of the pulley and are symmetrical about the centerline CL. For pulleys with an even number of total grooves, there will be two “number 1” grooves that are adjacent to (straddle) the centerline CL rib of the pulley. For pulleys with an even number of grooves the pulley rib angle for the rib between the adjacent “number 1” grooves is equal to the “number 1” groove angle. For pulleys with an odd number of total grooves, there is only one “number 1” groove and it is centered on the centerline CL of the pulley.

As shown in FIG. 3, the rib spacing and rib angle decrease for each rib disposed outward from the center rib. FIG. 3 depicts a 10 groove, 9 rib belt. This is only an example and is not intended to limit the scope of the invention. The inventive pulley may be used for belts having three or more ribs with equal success.

In addition, the inventive pulley compensates for the distortion of the rib angles caused when the belt is under a tensile load. Since the belt ribs are drawn slightly inward toward a belt longitudinal centerline under load, the angles for pulley grooves are progressively reduced as they are displaced from the pulley centerline.

The angle for the pulley grooves of the improved pulley are calculated from Equation 2:

$$\begin{matrix}Equation 2 \text{-} Pulley Groove Angle & \\ {θ}_{n} = {a}_{n} + \frac{b}{π} \times {tan}^{- 1} ( \frac{t - 2 n - 4}{3} ) + \frac{b}{2} & \end{matrix}$$

Where:
θₙ=pulley groove angle, in degrees, for the n^{th} pulley groove
n=number of pulley rib
t=total number of grooves in the pulley
aₙ=θ−[% stretch×(8.2t+2n)]
b=% stretch×(6t+θ)
   Where:
θ=nominal pulley groove angle in degrees
% stretch=the percent stretch in the belt at normal design tensile load.

### Example 1

Pulley dimensions are calculated in Table 1 and shown in FIG. 3 for engaging a 10 rib, multiple ribbed belt with a nominal rib spacing (S_{g}) of 0.092″ (2.34 mm), a nominal rib angle (θ) of 40°, operating at a tensile load resulting in 10% stretch, using a standard ball diameter (d_{B}) of 0.0625″ (1.59 mm). The improved belt/pulley combination groove and rib relationship is shown in FIG. 4.

TABLE 1
Pulley groove dimensions - example

| | Pulley groove number - n | | | | |
|---|---|---|---|---|---|
| | 1 | 2 | 3 | 4 | 5 |
| Groove | 39.6° | 38.3° | 36.2° | 34.1° | 32.8° |
| angle - | | | | | |
| θₙ | | | | | |
| Rib | 0.0920″ | 0.0908″ | 0.0890″ | 0.0872″ | 0.0861″ |
| Spacing - | 2.34 mm | 2.31 mm | 2.26 mm | 2.21 mm | 2.19 mm |
| S_{gn} | | | | | |

### Example 2

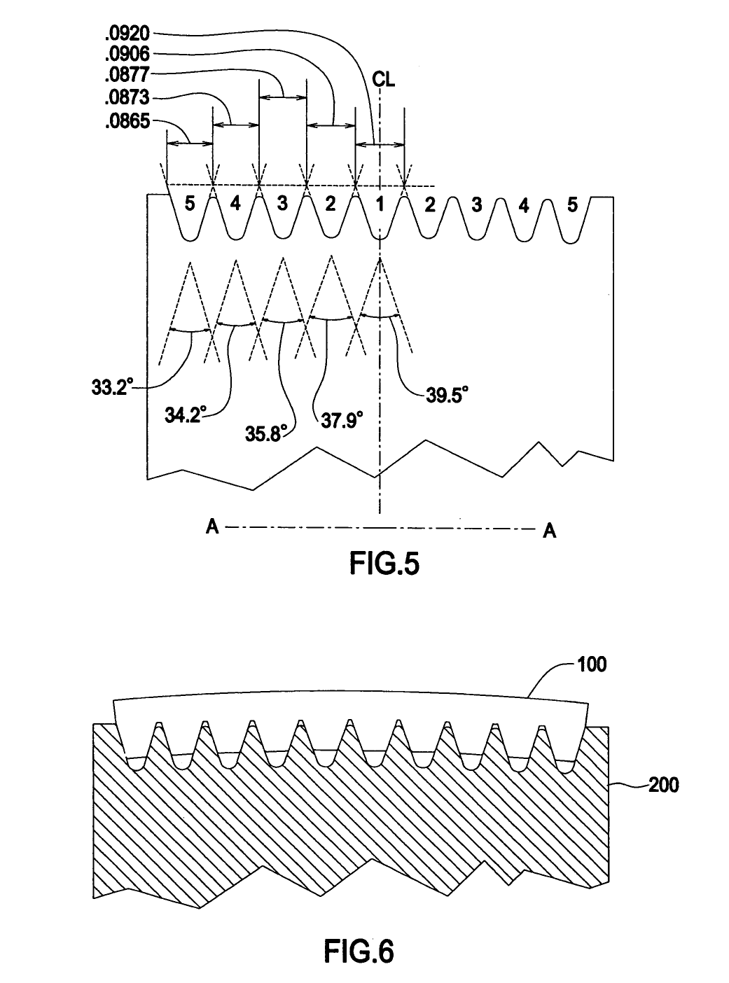

Pulley dimensions are calculated in Table 2 and shown in FIG. 5 for engaging a 9 rib multiple ribbed belt with a nominal belt rib spacing (S_{g}) of 0.092″ (2.34 mm), a nominal belt rib angle (θ) of 40°, operating at a tensile load resulting in a 10% stretch, using a standard ball diameter (d_{B}) of 0.0625″ (1.59 mm). % stretch refers to the increase in overall length caused by the belt load.

TABLE 2
Pulley groove dimensions - example

| | Pulley groove number - n | | | | |
|---|---|---|---|---|---|
| | 1 | 2 | 3 | 4 | 5 |
| Groove | 39.5° | 37.9° | 35.8° | 34.2° | 33.2° |
| angle - | | | | | |
| θₙ | | | | | |
| Rib | 0.0920″ | 0.0906″ | 0.0877″ | 0.0873″ | 0.0865″ |
| Spacing - | 2.34 mm | 2.30 mm | 2.25 mm | 2.22 mm | 2.20 mm |
| S_{gn} | | | | | |

FIG. 6 is a cross-sectional view of a tensile loaded belt engaged with an inventive pulley. The rib and groove spacing assures proper contact between the belt and the pulley across the entire width of the belt.

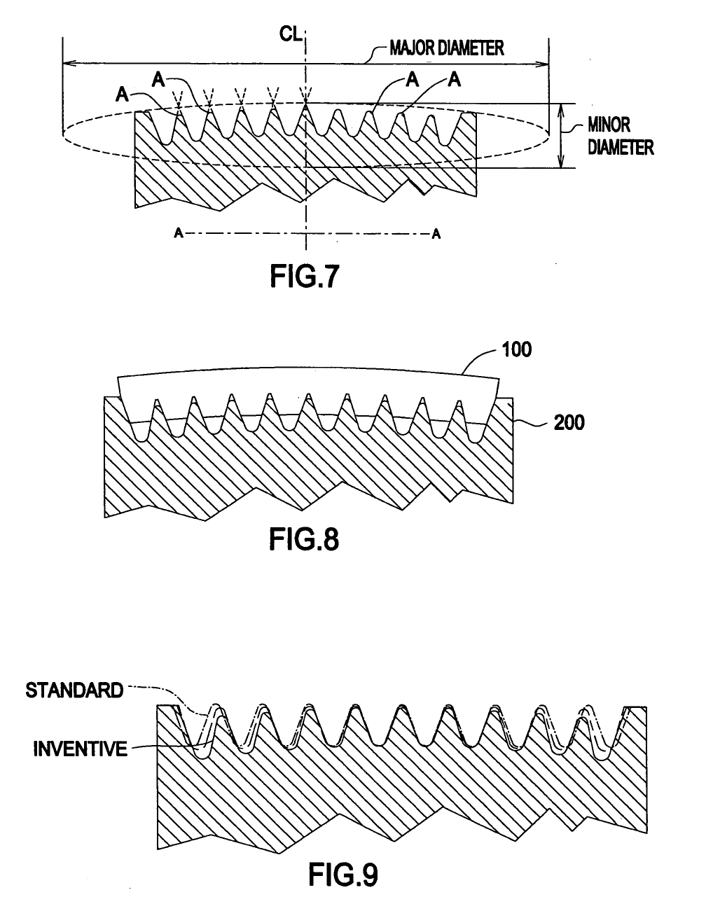

When placed in a standard pulley, the outer sections of the belt are at higher operating tension than the center of the belt. This uneven loading decreases the belt's ability to transmit power when compared to a belt that is uniformly loaded. Therefore, to further enhance the efficiency of the inventive pulley, the pulley profile can be slightly curved so that belt cord loading is consistent across the width of the entire belt section. Pulley profile curvature as determined by the positions of the apexes (A) of the plurality of ribs is defined by an ellipse, see FIG. 7. Pulley groove spacing and pulley groove angles are determined by Equations 1 and 2, respectfully. Referring to FIG. 7, the dimension and orientation of the ellipse are described by the following:

Major diameter=1.5×nominal width of the belt.

Minor diameter=2×the nominal pulley rib spacing.

Major diameter orientation: the major diameter orientation is substantially parallel with the axis of rotation (A-A) of the pulley and the curvature of the apexes (A) is substantially concave in the direction of the pulley axis (A-A).

For example, the belt properties for a typical belt to be used with the proposed pulley would have longitudinal elastic properties similar to those shown in Chart 1 and a nominal modulus of 1530 lbs/rib (6800 N/rib) in the working tension range—i.e. at approximately 8% strain (stretch). The nominal width is determined by the number of ribs, namely,
Nominal Belt Width=# of belt ribs×2.34 mm.

[image]

FIG. 8 is a schematic cross-sectional view of the inventive curved pulley configuration. The belt shown as an example has a nominal width of 23.4 mm. Using the foregoing equations, the major diameter=23.4 mm×1.5=35.1 mm. The minor diameter=2×the nominal pulley rib spacing=2×0.092″ (2.34 mm)=4.68 mm. The foregoing belt and calculations are only offered by way of example and are not intended to limit the scope of the invention.

The curve of the belt substantially aligns with the curved configuration of the pulley ribs. FIG. 8 depicts the arc form of the pulley apexes described in FIG. 7. This pulley configuration assures full contact of the belt with the pulley, thereby maximizing power transmission between the belt and pulley. The pulley shown in FIG. 8 comprises the ribs spacing described for FIG. 3 as well as the elliptical relationship for the pulley curvature as described for FIG. 7.

FIG. 9 is a cross-sectional view of a comparison of the profile of a prior art pulley and the profile of an inventive pulley. The significant difference in the prior art engagement between the belt and pulley as compared to the inventive combination is clearly evident.

Although forms of the invention have been described herein, it will be obvious to those skilled in the art that variations may be made in the construction and relation of parts without departing from the spirit and scope of the invention described herein.

We claim:

1. A multiple ribbed pulley and belt system comprising:
a multiple ribbed belt;
a pulley comprising;
a hub connected to a belt bearing surface;
the belt bearing surface having a profile comprising pulley ribs and pulley grooves;
the spacing of the pulley ribs with respect to a pulley centerline (CL) is determined according to the following equation;
$${S}_{gn} = tan ( \frac{{θ}_{n}}{2} ) \times [ {d}_{B} \times ( \frac{1}{sin ( {θ}_{n} / 2 )} - \frac{1}{sin ( {θ}_{1} / 2 )} ) + \frac{{S}_{g}}{tan ( {θ}_{1} / 2 )} ]$$
where
S_{gn}=rib spacing for n^{th} pulley rib
S_{g}=nominal pulley rib spacing
d_{B}=ball diameter;
the angle of each pulley groove is determined according to the following equation;
$${θ}_{n} = {a}_{n} + \frac{b}{π} \times {tan}^{- 1} ( \frac{t - 2 n - 4}{3} ) + \frac{b}{2}$$
where
θₙ=pulley groove angle, in degrees, for the n^{th} pulley groove
n=number of pulley rib
t=total number of pulley grooves in the pulley
aₙ=θ−[% stretch×(8.2t+2n)]
b=% stretch×(6t+θ)
where
θ=nominal pulley groove angle in degrees
% stretch=the percent stretch of the belt when subjected to a tensile load.

2. The multiple ribbed pulley and belt system as in claim 1 further comprising:
a curvature for an apex of the pulley ribs substantially describing an ellipse described by the following:
a major diameter=approximately 1.5×a nominal width of the belt,
a minor diameter=approximately 2×a nominal pulley rib spacing; and
the major diameter orientation is substantially parallel with the axis of rotation (A-A) of the pulley and the curvature is substantially centered on a pulley axis (CL).

3. A multiple ribbed pulley comprising:
a belt bearing surface having a plurality of pulley ribs and pulley grooves;
a pulley rib spacing between adjacent pulley ribs that progressively decreases as a distance (D) progressively increases from a pulley centerline (CL); and
a pulley groove angle which progressively decreases as the distance (D2) progressively increases from a pulley centerline (CL).

4. The multiple ribbed pulley as in claim 3 further comprising:
a curvature for the apexes (A) of the pulley ribs substantially describing an ellipse comprising;
a major diameter=approximately 1.5×a nominal width of a belt;
a minor diameter=approximately 2×a nominal pulley rib spacing; and
the major diameter orientation is substantially parallel with the axis of rotation (A-A) of the pulley and the curvature of the apexes is substantially concave in the direction of the axis of rotation (A-A).

5. A multiple ribbed pulley comprising:
a belt bearing surface having a plurality of pulley ribs and pulley grooves; and
a pulley rib spacing between adjacent pulley ribs that progressively decreases as a distance (D) progressively increases from a pulley centerline (CL).

6. The multiple ribbed pulley as in claim 5 further comprising:
a pulley groove angle which progressively decreases as the distance (D2) progressively increases from a pulley centerline (CL).

7. The multiple ribbed pulley as in claim 5, wherein:
the spacing of the pulley ribs in a direction from a pulley centerline (CL) is determined according to the following equation;
$${S}_{gn} = tan ( \frac{{θ}_{n}}{2} ) \times [ {d}_{B} \times ( \frac{1}{sin ( {θ}_{n} / 2 )} - \frac{1}{sin ( {θ}_{1} / 2 )} ) + \frac{{S}_{g}}{tan ( {θ}_{1} / 2 )} ]$$
where:
S_{gn}=rib spacing for n^{th} pulley rib
S_{g}=nominal pulley rib spacing
d_{B}=ball diameter
θₙ=pulley groove angle, in degrees, for the n^{th} pulley groove.

8. The multiple ribbed pulley as in claim 5, wherein:
the angle of each pulley groove is determined according to the following equation;
$${θ}_{n} = {a}_{n} + \frac{b}{π} \times {tan}^{- 1} ( \frac{t - 2 n - 4}{3} ) + \frac{b}{2}$$
where
θₙ=pulley groove angle, in degrees, for the n^{th} pulley groove
n=number of pulley rib
t=total number of pulley grooves in the pulley
aₙ=θ−[% stretch×(8.2t+2n)]
b=% stretch×(6t+θ)
where
θ=nominal pulley groove angle in degrees % stretch=the percent stretch of the belt when subjected to a tensile load.
